(19) United States
(12) Patent Application Publication
(10) Pub. No.: US 2012/0166749 A1
(43) Pub. Date: Jun. 28, 2012

(54) DATA MANAGEMENT IN SOLID-STATE STORAGE DEVICES AND TIERED STORAGE SYSTEMS

(75) Inventors: Evangelos S. Eleftheriou, Rueschlikon (CH); Robert Haas, Rueschlikon (CH); Xiao-Yu Hu, Rueschlikon (CH)

(73) Assignee: INTERNATIONAL BUSINESS MACHINES CORPORATION, Armonk, NY (US)

(21) Appl. No.: 13/393,684

(22) PCT Filed: Sep. 7, 2010
(86) PCT No.: PCT/IB2010/054028

§ 371 Date: Mar. 1, 2012

(30) Foreign Application Priority Data
Sep. 8, 2009 (EP) 09169726.8

(51) Int. Cl. G06F 12/02

(52) U.S. Cl. 711/165; 711/E12.002

(57) ABSTRACT

A method for managing data in a data storage system having a solid-state storage device and alternative storage includes identifying data to be moved in the solid-state storage device for internal management of the solid-state storage; moving at least some of the identified data to the alternative storage instead of the solid-state storage; and maintaining metadata indicating the location of data in the solid-state storage device and the alternative storage.

### PRIORITY

This is a U.S. national stage of application No. PCT/IB2010/054028, filed on 7 Sep. 2010. Priority under 35 U.S.C. §119(a) and 35 U.S.C. §365(b) is claimed from European Patent Application No. 09169726.8, filed 8 Sep. 2009, and all the benefits accruing therefrom under 35 U.S.C. §119, the contents of which in its entirety are herein incorporated by reference.

### BACKGROUND

This invention relates generally to management of data in solid-state storage devices and tiered data storage systems. Methods and apparatus are provided for managing data in tiered data storage systems including solid-state storage devices. Solid-state storage devices and data storage systems employing such methods are also provided.

Solid-state storage is non-volatile memory which uses electronic circuitry, typically in integrated circuits (ICs), for storing data rather than conventional magnetic or optical media like disks and tapes. Solid-state storage devices (SSDs), particularly flash memory devices, are currently revolutionizing the data storage landscape. This is because they offer exceptional bandwidth as well as random I/O (input/output) performance that is orders of magnitude better than that of hard disk drives (HDDs). Moreover, SSDs offer significant savings in power consumption and are more rugged than conventional storage devices due to the absence of moving parts.

In solid-state storage devices like flash memory devices, it is necessary to perform some kind of internal management process involving moving data within the solid-state memory. The need for such internal management arises due to certain operating characteristics of the solid-state storage. To explain the need for internal management, the following description will focus on particular characteristics of NAND-based flash memory, but it will be understood that similar considerations apply to other types of solid-state storage.

Flash memory is organized in units of pages and blocks. A typical flash page is 4 kB in size, and a typical flash block is made up of 64 flash pages (thus 256 kB). Read and write operations can be performed on a page basis, while erase operations can only be performed on a block basis. Data can only be written to a flash block after it has been successfully erased. It typically takes 15 to 25 microseconds (μs) to read a page from flash cells to a data buffer inside a flash die. Writing a page to flash cells takes about 200 μs, while erasing a flash block normally takes 2 milliseconds (ms) or so. Since erasing a block takes much longer than a page read or write, a write scheme known as “write-out-of-place” is commonly used to improve write throughput and latency. A stored data page is not updated in-place in the memory. Instead, the updated page is written to another free flash page, and the associated old flash page is marked as invalid. An internal management process is then necessary to prepare free flash blocks by selecting an occupied flash block, copying all still-valid data pages to another place in the memory, and then erasing the block. This internal management process is commonly known as “garbage collection”.

The garbage collection process is typically performed by dedicated control apparatus, known as a flash controller, accompanying the flash memory. The flash controller manages data in the flash memory generally and controls all internal management operations. In particular, the flash controller runs an intermediate software level called “LBA-PBA (logical block address-physical block address) mapping” (also known as “flash translation layer” (FTL) or “LPN-FPN (logical page number-flash page number) address mapping”. This maintains metadata in the form of an address map which maps the logical addresses associated with data pages from upper layers, e.g., a file system or host in a storage system, to physical addresses (flash page numbers) on the flash. This software layer hides the erase-before-write intricacy of flash and supports transparent data writes and updates without intervention of erase operations.

Wear-levelling is another internal management process performed by flash controllers. This process addresses the wear-out characteristics of flash memory. In particular, flash memory has a finite number of write-erase cycles before the storage integrity begins to deteriorate. Wear-levelling involves various data placement and movement functions that aim to distribute write-erase cycles evenly among all available flash blocks to avoid uneven wear, so lengthening overall lifespan. In particular, wear-levelling functionality governs selecting blocks to which new data should be written according to write-erase cycle counts, and also moving stored data within the flash memory to release blocks with low cycle counts and even out wear.

The internal management functions just described, as well as other processes typically performed by SSD controllers, lead to so-called “write amplification”. This arises because data is moved internally in the memory, so the total number of data write operations is amplified in comparison with the original number of data write requests received by the device. Write amplification is one of the most critical issues limiting the random write performance and write endurance lifespan in solid-state storage devices. To alleviate this effect, SSDs usually use a technique called over-provisioning, whereby more memory is employed than that actually exposed to external systems. This makes SSDs comparatively costly.

The cost versus performance trade-off among different data storage devices lies at the heart of tiered data storage systems. Tiered storage, also known as hierarchical storage management (HSM), is a data storage technique in which data is automatically moved between different storage devices in higher-cost and lower-cost storage tiers or classes. Tiered storage systems exist because high-speed storage devices, such as SSDs and FC/SCSI (fiber channel/small computer system interface) disk drives, are more expensive (per byte stored) than slower devices such as SATA (serial advanced technology attachment) disk drives, optical disc drives and magnetic tape drives. The key idea is to place frequently-accessed (or “hot”) data on high-speed storage devices and less-frequently-accessed (or “cold”) data on lower speed storage devices. Data can also be moved (migrated) from one device to another device if its access pattern is changed. Sequential write data that is a long series of data with sequential logical block addresses (LBAs), in a write request may be preferentially written to lower cost media like disk or tape. Tiered storage can be categorized into LUN (logical unit number)-level, file-level and block-level systems according the granularity of data placement and migration. The finer the granularity, the better the performance per unit cost.

The general architecture of a previously-proposed block-level tiered storage system is illustrated in FIG. 1 of the accompanying drawings. The system 1 includes a flash memory SSD 2 together with alternative, lower-cost storage. In this example, the alternative storage comprises an HDD array 3, and optionally also a tape drive 4. SSD 2 comprises an array of flash memory dies 5 and a flash controller 6 which performs the various flash management operations discussed above. The storage modules 2 to 4 are connected via a communications link 7 to a storage controller 8 which receives all data read and write requests to the system. The storage controller 8 manages data in the system generally, performing automated data placement and data migration operations such as identifying hot and cold data and placing or migrating data among the different storage media. Storage controller 8 maintains a global address map to track the location of data in the system as well as the bulk movement of data chunks between storage devices. The activity of the flash controller 6 explained earlier is transparent to the storage controller 8 in this architecture.

### BRIEF DESCRIPTION OF THE SEVERAL VIEWS OF THE DRAWINGS

Exemplary embodiments will now be described, by way of example, with reference to the accompanying drawings in which:

FIG. 1 shows the architecture of a previously-proposed data storage system;

FIG. 2 shows the architecture of data storage system in accordance with an exemplary embodiment;

FIG. 3 is a schematic block diagram of a flash controller in the FIG. 2 system;

FIG. 4 illustrates data placement functionality of the flash controller of FIG. 3;

FIG. 5 illustrates a data management process performed as part of internal management operations in the flash controller;

FIG. 6 illustrates a modification to the process of FIG. 5;

FIG. 7 illustrates operation of the flash controller in response to a read request; and

FIG. 8 shows an example of metadata maintained by the flash controller.

### DETAILED DESCRIPTION

One aspect of the present embodiments provides a method for managing data in a data storage system having a solid-state storage device and alternative storage. The method includes identifying data to be moved in the solid-state storage device for internal management of the solid-state storage; moving at least some of the data so identified to the alternative storage instead of the solid-state storage; and maintaining metadata indicating the location of data in the solid-state storage device and the alternative storage.

Embodiments provide data management methods for use in data storage systems having a solid-state storage device and alternative storage as, for example, in the tiered data storage systems discussed above. In methods embodying the invention, essential internal management processes in the solid-state storage device are used as a basis for managing data movement between different storage media. In particular, as explained earlier, such processes identify data which needs to be moved in the solid-state storage for internal management purposes. In embodiments, at least some of this data is moved to the alternative storage instead of the solid-state storage. Some form of metadata, such as an LBA/PBA address map, indicating the location of data in the SSD and alternative storage is maintained accordingly to keep track of data so moved.

The embodiments are predicated on the realization that the operation of routine internal management processes in SSDs is inherently related to data access patterns. Embodiments can exploit information on data access patterns which is “buried” in internal management processes, using this as a basis for managing data movements at system level, i.e., between storage media. In particular, internal management processes in SSDs inherently involve identification of data which is relatively static (i.e. infrequently updated) compared to other data in the memory. This can be exploited as a basis for selecting data to be moved to the alternative storage, leading to a simpler, more efficient data management system. In hierarchical data storage systems, for example, embodiments of the invention provide the basis for simple and efficient system-level data migration policies, reducing implementation complexity and offering improved performance and reduced cost compared to prior systems. Moreover, by virtue of the nature of the internal SSD management operations, the identification of relatively static data is adaptive to overall data access patterns in the solid-state memory, in particular the total amount of data being stored and the comparative update frequency of different data. System-level data management can thus be correspondingly adaptive, providing better overall performance. In addition, the migration of relatively static data out of the solid-state memory has significant benefits in terms of performance and lifetime of the solid-state memory itself, providing still further improvement over prior systems. Overall therefore, embodiments offer dramatically improved data storage and management systems.

In general, different SSDs may employ a variety of different internal management processes involving moving data in the solid-state memory. Where a garbage collection process is employed, however, this is exploited as discussed above. Thus, methods embodying the invention may include identifying data to be moved in a garbage collection process in the solid-state storage device and moving at least some of that data to the alternative storage instead of the solid-state storage. Similarly, where wear-levelling is employed in the SSD, the data management process can include identifying data to be moved in the wear-levelling process and moving at least some of that data to the alternative storage instead of the solid-state storage.

In particularly simple embodiments, all data identified to be moved in a given internal management process could be moved to the alternative storage instead of the solid-state storage. In other embodiments, only some of this data could be selected for movement to alternative storage, e.g. in dependence on some additional information about the data such as additional metadata indicative of access patterns which is maintained in the system. This will be discussed further below.

A second aspect provides control apparatus for a solid-state storage device in a data storage system having alternative storage. The apparatus comprises memory and control logic adapted to: identify data to be moved in the solid-state storage device for internal management of the solid-state storage; control movement of at least some of the data so identified to the alternative storage instead of the solid-state storage; and maintain in the memory metadata indicating the location of data in the solid-state storage device and the alternative storage.

The control logic includes integrated logic adapted to perform the internal management of the solid-state storage. Thus, the additional functionality controlling moving data to the alternative storage as described can be fully integrated with the basic SSD control functionality in a local SSD controller.

The control apparatus can manage various further system-level data placement and migration functions. For example, in particularly preferred embodiments, the control logic can control migration of data from the alternative storage back to the solid-state memory, and can control writing of sequential data to alternative storage instead of the SS memory. This will be described in more detail below.

The extent to which the overall system level data placement and migration functionality is integrated in a local SSD controller can vary in different embodiments. In preferred embodiments, however, the control apparatus can be implemented in a local SSD controller which provides a self-contained, fully-functional data management system for local SSD and system-level data placement and migration management.

While alternatives might be envisaged, the metadata maintained by the control apparatus comprises at least one address map indicating mapping between logical addresses associated with respective blocks of data and physical addresses indicative of data locations in the solid-state storage device and the additional storage. The metadata is maintained at least for all data moved between storage media by the processes described above, but typically encompasses other data depending on the level of integration of the control apparatus with basic SSD control logic and the extent of system-level control provided by the control apparatus. In preferred, highly-integrated embodiments however, the control apparatus can maintain a global address map tracking data throughout the storage system.

A third aspect provides a computer program comprising program code means for causing a computer to perform a method according to the first aspect or to implement control apparatus according to the second aspect.

It will be understood that the term “computer” is used in the most general sense and includes any device, component or system having a data processing capability for implementing a computer program. Moreover, a computer program embodying the invention may constitute an independent program or may be an element of a larger program, and may be supplied, for example, embodied in a computer-readable medium such as a disk or an electronic transmission for loading in a computer. The program code means of the computer program may comprise any expression, in any language, code or notation, of a set of instructions intended to cause a computer to perform the method in question, either directly or after either or both of (a) conversion to another language, code or notation, and (b) reproduction in a different material form.

A fourth aspect provides a solid-state storage device for a data storage system having alternative storage, the device comprising solid-state storage and control apparatus according to the second aspect of the invention.

A fifth aspect provides a data storage system comprising a solid-state storage device according to the fourth aspect of the invention and alternative storage, and a communications link for communication of data between the solid-state storage device and the alternative storage.

In general, where features are described herein with reference to an embodiment of one aspect of the invention, corresponding features may be provided in embodiments of another aspect of the invention.

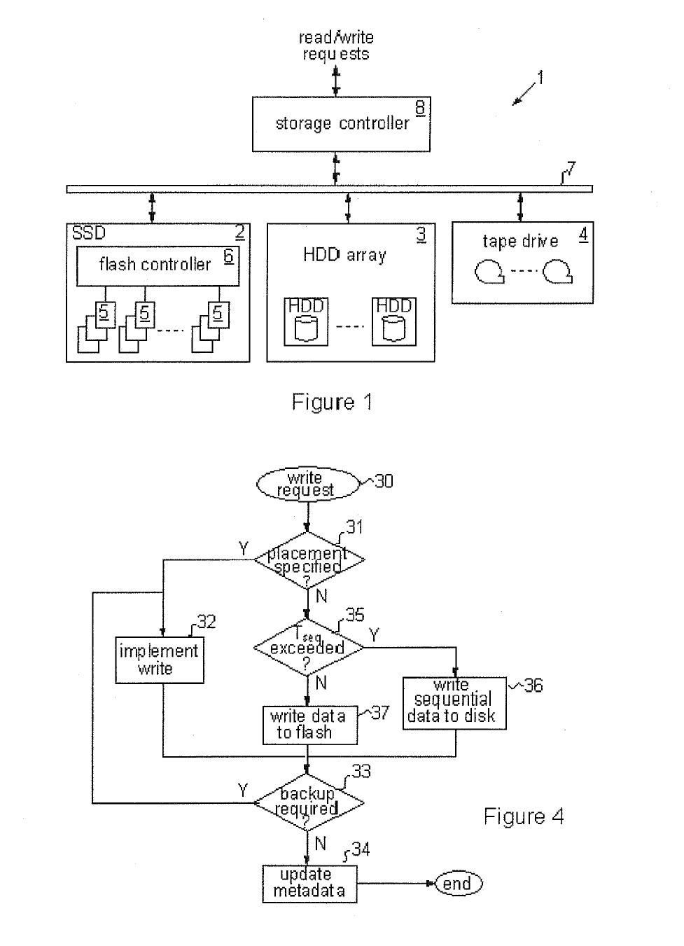

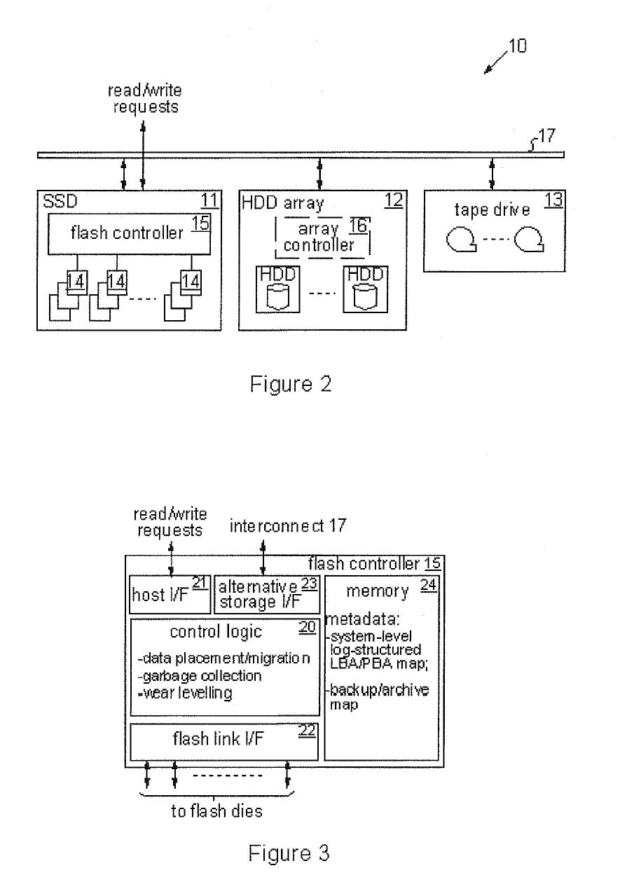

FIG. 2 illustrates the general architecture of one example of a data storage system that may be used in accordance with exemplary embodiments. The system 10 is a tiered storage system with a broadly similar storage structure to the system 1 of FIG. 1, having an SSD 11 and alternative storage provided by an HDD array 12 and a tape drive module 13. The SSD 11 has an array of flash memory dies 14 and a flash controller 15. The HDD array 12 comprises a plurality of hard disk drives. In addition to the usual internal control functionality in individual HDDs, the HDD array may optionally include an array controller 16 as indicated by the broken lines in the figure. Such an array controller can perform array-level control functions in array 12, such as RAID (redundant array of independent devices) management, in known manner. An interconnect 17 provides a data communications link between the hierarchical storage modules 11 to 13.

Unlike the prior architecture, all data read/write requests from hosts using system 10 are supplied directly to SSD 11 and received by flash controller 15. The flash controller 15 is shown in more detail in FIG. 3. This schematic block diagram shows the main elements of flash controller 15 involved in the data management processes to be described. The controller 15 includes control logic 20, a host interface (I/F) 21 for communication of data with system hosts, and a flash link interface 22 for communication over links to the array of flash dies 14. Flash controller 15 also includes interface circuitry 23 for communication of data with the alternative storage devices, here HDD array 12 and tape drive 13, via interconnect 17. Control logic 20 controls operation of SSD 11, performing the usual control functions for read/write and internal management operations but with modifications to these processes as described in detail below. In particular, control logic 20 implements modified garbage collection and wear-levelling processes, as well as system-level data placement and migration operations which will be described hereinafter. Other routine flash controller functions, such as flash link management, write reduction and bad-block management, can be performed in the usual manner and need not be described here. In general, the control logic 20 could be implemented in hardware, software or a combination thereof. In this example, however, the control logic is implemented by software which configures a processor of controller 15 to perform the functions described. Suitable software will be apparent to those skilled in the art from the description herein. Flash controller 15 further includes memory 24 for storing various metadata used in operation of the controller as described further below.

In operation of system 10, read/write requests from hosts are received by flash controller 15 via host I/F 21. Control logic 20 controls storage and retrieval of data in local flash memory 14 and also, via storage I/F 23, in alternative storage devices 12, 13 in response to host requests. In addition, the control logic implements a system-wide data placement and migration policy controlling initial storage of data in the system, and subsequent movement of data between storage media, for efficient use of system resources. To track the location of data in the system, the metadata stored in memory 24 includes an address map indicating the mapping between logical addresses associated with respective blocks of data and physical addresses indicative of data locations in the flash memory 14 and alternative storage 12, 13. In particular, the usual log-structured LBA/PBA map tracking the location of data within flash memory 14 is extended to system level to track data throughout storage modules 11 to 13. This system-level map is maintained by control logic 20 in memory 24 as part of the overall data management process. The log-structured form of this map means that old and updated versions of data coexisting in the storage system are associated in the map, allowing appropriate internal management processes to follow-up and erase old data as required. A particular example of an address map for this system will be described in detail below. In this example, control logic 20 also manages storage of backup or archive copies of data in system 10. Such copies may be required pursuant to host instructions and/or maintained in accordance with some general policy implemented by control logic 20. In this embodiment, therefore, the metadata maintained by control logic 20 includes a backup/archive map indicating the location of backup and archive data in system 10.

Operation of the flash controller 15 in response to a write request from a host is indicated in the flow chart of FIG. 4. This illustrates the data placement process implemented by control logic 20. On receipt of a write request at block 30, the control logic 20 first checks whether the request indicates specific storage instructions for the write data. For example, hosts might indicate that data should be stored on a particular medium, or that data should be archived or backed-up in the system. If data placement is specified for the write data, as indicated by a “Yes” (Y) at decision block 31, then operation proceeds to block 32. Here, control logic 20 implements the write request, controlling writing of data via flash I/F 22 or storage I/F 23 to the appropriate medium 14, 12, 13. Next, the control logic determines at block 33 if a backup copy of the data is required, by host instruction or predetermined policy, and if so operation reverts to block 32 to implement the backup write. The medium selected here can be determined by policy as discussed further below. After effecting the backup write, the operation returns to block 33 and this time proceeds (via branch “No” (N) at block 33) to block 34. Here the control logic 20 updates the metadata in memory 24 to record the location of the written data in the address map(s) as appropriate.

Returning to block 31, if no particular placement is specified for write data here (N at this decision block), then operation proceeds to block 35 where the control logic checks if the write request is for sequential data. Sequential data might be detected in a variety of ways as will be apparent to those skilled in the art. In this example, however, control logic 20 checks the request size for sequentially-addressed write data against a predetermined threshold T_{seq}. That is, for write data with a sequential series of logical block addresses (LBAs), if the amount of data exceeds T_{seq} then the data is deemed sequential. In this case (Y at decision block 35), operation proceeds to block 36 where logic 20 controls writing of the sequential data to disk in HDD array 12. Operation then continues to block 33. Returning to decision block 35, for non-sequential write data (N at this block), operation proceeds to block 37 where the control logic writes the data to flash memory 14, and operation again proceeds to block 33. After writing data to disk or flash memory in block 36 or 37, backup copies can be written if required at block 33, and the metadata is then updated in block 34 as before to reflect the location of all written data. The data placement operation is then complete.

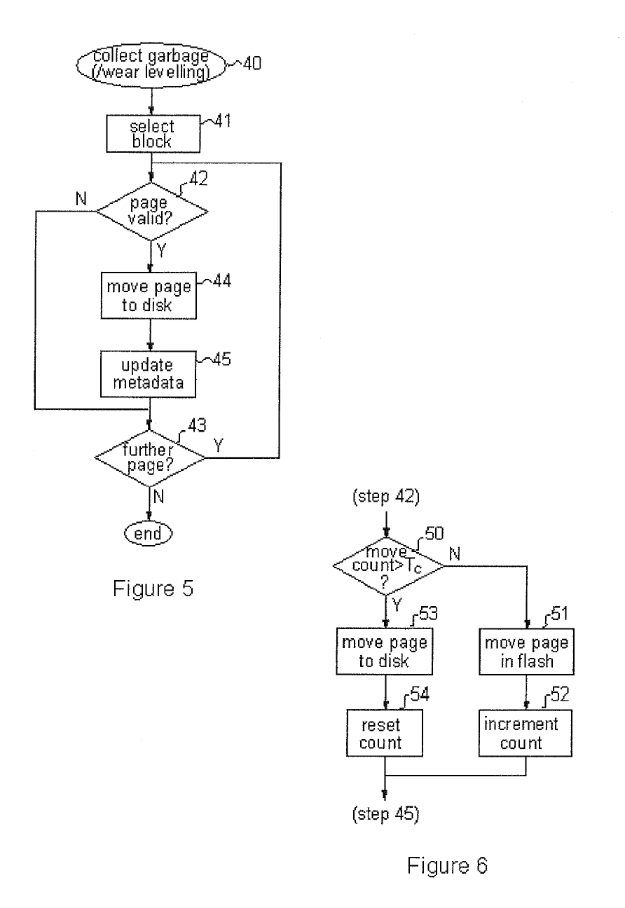

It will be seen from FIG. 4 that flash controller 15 implements a system-level data placement policy. In particular, sequential data is written to disk in this example, non-sequential data being written to flash memory, unless host instruction or other policy dictates otherwise. In addition to this data placement functionality, flash controller 15 also manages migration of data between media. The process for migrating data from flash memory 14 to alternative storage is intimately connected with the essential internal management operations performed by flash controller 15. This is illustrated in the flow chart of FIG. 5 which shows the garbage collection process performed by flash controller 15 for internal management of flash memory 14. When garbage collection is initiated at block 40 of FIG. 5, control logic 20 first selects a flash block for erasure as indicated at block 41. This selection is performed in the usual manner, typically by identifying the block with the most invalid pages. Next, in block 42, control logic 20 determines if the first page in the block is valid. If not, then operation proceeds to block 43 where the control logic decides if there are any further pages in the block. Assuming so, operation will revert to block 42 for the next page. When a valid page is detected at block 42, operation proceeds to block 44. Here, instead of copying the page to another location in flash memory 14, control logic 20 moves the page to disk. Hence, in block 44 the control logic 20 sends the page via I/F 23 for writing in HDD array 12. In block 45 the control logic then updates the metadata in memory 24 to record the new location of the moved page. Operation then proceeds to block 43 and continues for the next flash page. When all flash pages in the block have been dealt with (N at block 43), the garbage collection process is complete for the current block. This process may then be repeated for further blocks as required. Once garbage collection has been performed for a block, this block can be subsequently erased to allow re-writing with new data as required. The erasure could be carried out immediately, or at any time subsequently when required to free flash memory for new data. In any case, when a block is erased, control logic 20 updates the metadata in memory 24 by deleting the old flash memory address of pages moved to disk.

By using garbage collection as the basis for migration of data from flash memory to disk, flash controller 15 exploits the information on data access patterns which is inherent in the garbage collection process. In particular, the nature of the process is such that data (valid pages) identified to be moved in the process tend to be relatively static (infrequently updated) compared to other data in the flash memory, for example newer versions of invalid pages in the same block. Flash controller 15 exploits this fact, moving the (comparatively) static data so identified to disk instead of flash memory. Moreover, the identification of static data by this process is inherently adaptive to overall data access patterns in the flash memory, since garbage collection will be performed sooner or later as overall storage loads increase and decrease. Thus, data pages effectively compete with each other to remain in the flash memory, this process being adaptive to overall use patterns.

In the simple process of FIG. 5, all data identified for movement during garbage collection is moved to disk instead of flash memory 14. However, a possible modification to this process is shown in FIG. 6. This illustrates an alternative to block 44 in FIG. 5. In the modified process, valid data pages identified in block 42 will be initially moved within flash memory 14, and control logic 20 maintains a count of the number of times that a given data page has been so moved. This move count can be maintained as additional metadata in memory 24. Referring to FIG. 6, following identification of a valid page in block 42 of FIG. 4, the control logic 20 compares the move count for that page with a preset threshold count T_{C}. If the move count does not exceed the threshold (N at decision block 50), the page is simply copied in block 51 to another location in flash memory 14. The move count for that page is then updated in block 52, and operation continues to block 45 of FIG. 5. Returning to block 50, if the move count exceeds the threshold here (Y), then the page is copied to disk in block 53. Control logic 20 then zeroes the move count for that page in block 54, and operation continues as before. While this modified process involves maintaining move counts as additional metadata, the count threshold T_{C} allows migration to be limited to situations where data has been repeatedly moved, this being more likely when use patterns are heavy and flash memory efficiency can be improved by migrating static data. The threshold T_{C} could even be adapted dynamically in operation in response to use patterns, e.g. as assessed by some higher level performance monitoring in control logic 20.

Flash controller 15 can also perform the data migration process of FIG. 5 in conjunction with the internal wear-levelling process in SSD 11. In particular, the normal wear-levelling functionality of control logic 20 involves identifying flash blocks with comparatively low write-erase cycle counts, and moving the data so identified to release blocks for rewriting, thereby evening-out cycle counts and improving wear characteristics. Again, data identified for movement by this internal management process is relatively static compared to other data, and this is exploited for the system-level data migration performed by flash controller 15. Hence, the process of FIG. 5 can be performed identically during wear-levelling as indicated in block 40, with the block selection of block 41 typically selecting the block with the lowest cycle count. Once again, the identification and movement of comparatively static data in this process is adaptive to overall usage patterns in flash memory 14. In addition, the modification of FIG. 6 could be employed for wear-levelling also, though the process of FIG. 5 is preferred for simplicity.

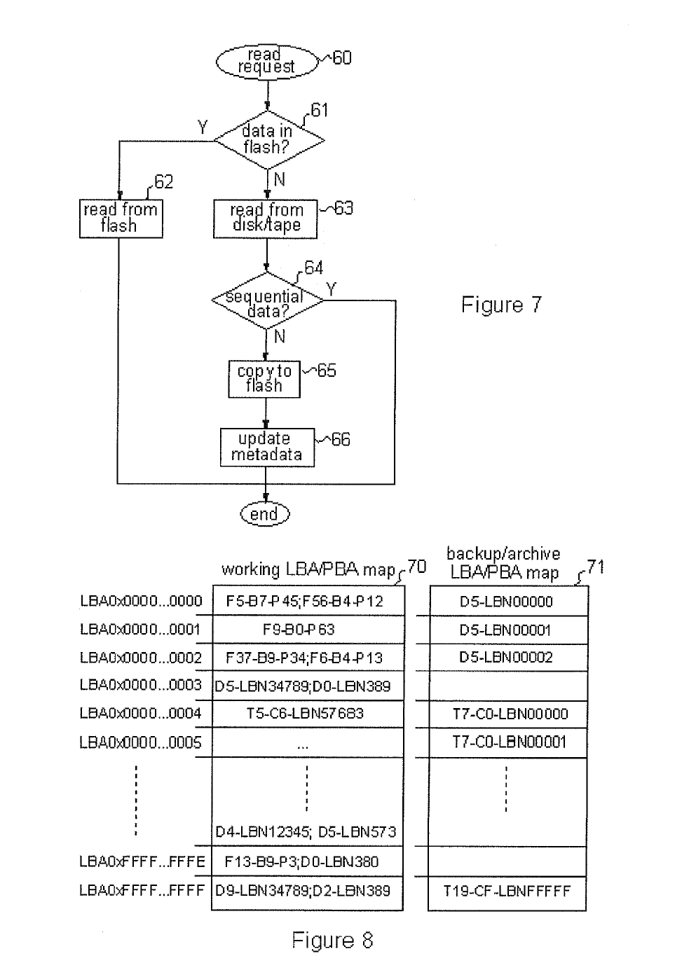

As well as distinguishing static from dynamic data as described above, the data migration policy implemented by flash controller 15 can further distinguish hot and cold data according to read access frequency. In particular, while static data is data which is comparatively infrequently updated in this system, cold data here is data which is (comparatively) infrequently read or updated. This distinction is embodied in the handling of read requests by flash controller 15. The key blocks of this process are indicated in the flow chart of FIG. 7. In response to a read request received at block 60, the control logic 20 first checks from the address map in memory 24 whether the requested data is currently stored in flash memory 14. If so (Y at decision block 61), then data is simply read out in block 62 and the process terminates. If at block 61 the required data is not in flash memory, then in block 63 the control logic controls reading of the data from the appropriate address location in disk array 12 or tape drive 13 as appropriate. Next, in decision block 64 control logic decides if the read request was for sequential data. Again this can be done, for example, by comparing the request size with the threshold T_{seq} as before. If identified as sequential data here (Y at block 64), then no further action is required. If, however, the read data is not deemed sequential, then in block 65 control logic 20 copies the read data back to flash memory 14. In block 66, the address map is updated in memory 24 to reflect the new data location, and the read process is complete.

The effect of the read process just described is that data migrated from flash to disk by the internal management processes described earlier will be moved back into flash memory in response to a read request for that data. Static, read-only data will therefore cycle back to flash memory, whereas truly cold data, which is not read, will remain in alternative storage. Since it normally takes quite some time for a data page to be deemed static after writing to flash, a frequently read-only page will remain quite some time in flash before being migrated to disk. Sequential data will tend to remain on disk or tape regardless of read frequency. In this way, efficient use is made of the different properties of the various storage media for different categories of data.

FIG. 8 is a schematic representation of the address maps maintained as metadata by control logic 20 in this example. The left-hand table in this figure represents the working LBA/PBA map 70, and the right-hand table represents the backup/archive map 71. For the purposes of this example, we assume that tape drive 13 is used primarily for archive data and for backup copies of data stored elsewhere on disk or tape. Where backup copies of data in flash memory are required, these are stored in HDD array 12. Considering the first line in the address maps, working map 70 indicates that the data with logical block address 0x0000 . . . 0000 is currently stored in flash memory at address F5-B7-P45 (where this format indicates the 45^{th} page (P) in the 7^{th} block (B) on the 5^{th} flash die (F)). An old version of this data is also held in flash at address F56-B4-P12. Map 71 indicates that a backup copy of this data is stored at address D5-LBN00000 (where this format indicates the 00000^{th} logical block number (LBN) in the 5^{th} HDD (D) of disk array 12). The second line indicates that the data with LBA 0x0000 . . . 0001 is stored in flash memory at address F9-B0-P63, with a backup on disk at D5-LBN00001. The fourth line indicates that LBA 0x0000 . . . 0003 is currently on disk at D5-LBN34789, with an older version of this data still held on disk at D0-LBN389 (e.g. following updating of this data on disk in append mode in the usual manner). The next line shows that LBA 0x0000 . . . 0004 is currently stored on tape at T5-C6-LBN57683 (where this format indicates the 57683 logical block number in the 6^{th} cartridge (C) of the 5^{th} tape drive (T)). A backup copy is stored at T7-C0-LBN00000. LBA 0x0000 . . . 0005 is archived without backup at T7-C0-LBN00001. In the penultimate line, LBA 0xFFFF . . . FFFE is currently stored in flash with an older version stored on disk, e.g. following copying of migrated data back to flash in block 65 of FIG. 7.

It will be seen that the log-structured address mapping tables 70, 71 allow data movements to be tracked throughout the entire storage system 10, with old and new versions of the same data being associated in working map 70 to facilitate follow-up internal management processes such as garbage collection. It will be appreciated, however, that various other metadata could be maintained by control logic 20. For example, the metadata might include further maps such as a replication map to record locations of replicated data where multiple copies are stored, e.g. for security purposes. Further metadata, such as details of access patterns, times, owners, access control lists (ACLs) etc., could also be maintained as will be apparent to those skilled in the art.

It will be seen that flash controller 15 provides a fully-integrated controller for local SSD and system-level data management. The system-level data migration policy exploits the inherent internal flash management processes, creating a synergy between flash management and system-level data management functionality. This provides a highly efficient system architecture and overall data management process which is simpler, faster and more cost-effective than prior systems. The system can manage hot/cold, static/dynamic, and sequential/random data in a simple and highly effective manner which is adaptive to overall data access patterns. In addition, the automatic migration of static data out of flash significantly improves the performance and lifetime of the flash storage itself. A further advantage is that backup and archive can be handled at the block level in contrast to the usual process which operates at file level. This offers faster implementation and faster recovery.

Various changes and modifications can of course be made to the preferred embodiments detailed above. Some examples are described hereinafter.

Although flash controller 15 provides a fully-functional, self-contained, system-level data management controller, additional techniques for discerning hot/cold or and/or static/dynamic data and placing/migrating data accordingly can be combined with the system described. This functionality could be integrated in flash controller 15 or implemented at the level of a storage controller 8 in the FIG. 1 architecture. For example, initial hot/cold data detection could be implemented in a storage controller 8, with cold data being written to disk or tape without first being written to flash. The accuracy of hot/cold detection would of course be crucial to any improvement here.

The data placement/migration policy is implemented at the finest granularity, block (flash page) level in the system described. However, those skilled in the art will appreciate that the system can be readily modified to handle variable block sizes up to file level, with the address map reflecting the granularity level.

The alternative storage may be provided in general by one or more storage devices. These may differ from the particular examples described above and could include another solid-state storage device.

While SSD 11 is assumed to be a NAND flash memory device above, other types of SSD may employ techniques embodying the invention. Examples here are NOR flash devices or phase change memory devices. Such alternative devices may employ different internal management processes to those described, but in general any internal management process involving movement of data in the solid-state memory can be exploited in the manner described above. Note also that while SSD 11 provides the top-tier of storage above, the system could also include one or more higher storage tiers.

It will be appreciated that many other changes and modifications can be made to the exemplary embodiments described without departing from the scope of the invention.

1. A method for managing data in a data storage system having a solid-state storage device and alternative storage, the method comprising:
identifying data to be moved in the solid-state storage device for internal management of the solid-state storage;
moving at least some of the identified data to the alternative storage instead of the solid-state storage; and
maintaining metadata indicating the location of data in the solid-state storage device and the alternative storage.

2. The method of claim 1, further comprising identifying data to be moved in a garbage collection process in the solid-state storage device and moving at least some of that data to the alternative storage instead of the solid-state storage.

3. The method of claim 1, further comprising identifying data to be moved in a wear-levelling process in the solid-state storage device and moving at least some of that data to the alternative storage instead of the solid-state storage.

4. A control apparatus for a solid-state storage device in a data storage system having alternative storage, the apparatus comprising memory and control logic adapted to:
identify data to be moved in the solid-state storage device for internal management of the solid-state storage;
control movement of at least some of the identified data to the alternative storage instead of the solid-state storage; and
maintain in the memory metadata indicating the location of data in the solid-state storage device and the alternative storage.

5. The apparatus of claim 4, wherein the control logic is adapted to identify data to be moved in a garbage collection process in the solid-state storage device and to control movement of at least some of the data to the alternative storage instead of the solid-state storage.

6. The apparatus of claim 5, wherein the control logic is adapted to control movement of all data to be moved in the garbage collection process to the alternative storage instead of the solid-state storage.

7. The apparatus of claim 5, wherein:
for data moved in the solid-state storage device in the garbage collection process, the control logic is adapted to maintain a count of the number of times that data has been so moved; and
upon identification of data to be moved in the garbage collection process, the control logic is adapted to control movement of that data to the alternative storage in the event the count for that data exceeds a threshold.

8. The apparatus of claim 4, wherein the control logic is adapted to identify data to be moved in a wear-levelling process in the solid-state storage device and to control movement of at least some of that data to the alternative storage instead of the solid-state storage.

9. The apparatus of claim 4, wherein the control logic includes integrated logic adapted to perform the internal management of the solid-state storage.

10. The apparatus of claim 4, wherein the control logic is adapted to:
receive read requests for reading data; and
in response to a read request for data moved from the solid-state storage to the alternative storage, to control writing of that data back to the solid-state storage.

11. The apparatus of claim 4, wherein the control logic is adapted to:
receive write requests for writing data;
determine if a received write request is for writing sequential data;
in the event the received write request is not for writing sequential data, to control writing of the data to the solid-state storage, and if so to control writing of the data to the alternative storage.

12. The apparatus of claim 4, wherein:
the solid-state storage comprises flash memory and/or the alternative storage comprises at least one of disk storage and tape storage.

13. The apparatus of claim 4, wherein the metadata comprises at least one address map indicating mapping between logical addresses associated with respective blocks of data and physical addresses indicative of data locations in the solid-state storage device and the alternative storage.

14. A computer readable storage medium having computer readable code stored thereon that, when executed by a computer, implement the method of claim 1.

15. A solid-state storage device for a data storage system having alternative storage, the device comprising solid-state storage and control apparatus as claimed in claim 4.

16. A data storage system comprising a solid-state storage device as claimed in claim 15 and alternative storage, and a communications link for communication of data between the solid-state storage device and the alternative storage.
